(19) United States
(12) Patent Application Publication
(10) Pub. No.: US 2012/0202491 A1
(43) Pub. Date: Aug. 9, 2012

(54) TELECOMMUNICATIONS NETWORKS

(76) Inventors: David Fox, Newbury (GB); Christopher David Pudney, Newbury (GB); Peter Howard, Newbury (GB)

(21) Appl. No.: 12/737,419

(22) PCT Filed: Jul. 10, 2009
(86) PCT No.: PCT/GB2009/001721

§ 371 Date: Jun. 13, 2011

(30) Foreign Application Priority Data
Jul. 10, 2008 (GB) 0812632.8

(51) Int. Cl. H04W 72/04; H04W 60/00; H04W 12/04

(52) U.S. Cl. 455/435.1; 455/450

(57) ABSTRACT

An SAE/LTE or 4G cellular telecommunications network is disclosed which comprises a plurality of eNodeBs and a network core. A plurality of mobile telecommunications devices are registered with the network and communicate with the network core via the eNodeBs. At least one relay is provided between the eNodeB and the mobile telecommunications devices to extend the radio coverage provided by the eNodeB. Radio Resource Control signalling is tunnelled between the mobile telecommunications device and the relay. A Relay Resource Control signalling protocol is additionally provided for tunnelling signalling between the relay and the node. One or more further relays may be provided in a communication path between the first-mentioned relay (the controlling relay) and the eNodeB.

### BACKGROUND TO THE INVENTION

The present invention relates to telecommunications networks, and more particularly, but not exclusively, to developments in such networks suitable for adoption in 3GPP SAE/LTE or 4^{th} generation (4G) mobile or cellular telecommunications networks that will be implemented in the future.

It is anticipated that SAE/LTE and 4G networks may provide the following advantages, compared to these known networks:—
1. Support interactive multimedia services: teleconferencing, wireless Internet, etc.
2. Wider bandwidths, higher bit rates.
3. Global mobility and service portability.
4. Scalability of mobile networks.
   and may be/have:—
5. Entirely packet-switched networks.
6. All network elements are digital.
7. Higher bandwidths to provide multimedia services at lower cost.
8. Tight network security.

### BRIEF SUMMARY OF THE INVENTION

According to the present invention, there is provided a mobile telecommunications network including a plurality of nodes and a network core, wherein a plurality of mobile telecommunications devices are registered with the network and communicate with the network core via the nodes, wherein at least one relay is provided between one of said nodes and one of said telecommunications devices to extend the radio coverage provided by the said node, wherein radio resource control signalling is securely tunnelled between the relay and the said node.

Mobility management and session management signalling may also be securely tunnelled between the relay and the said node.

The radio resource control, mobility management and/or session management signalling may be derived from the said device.

The radio resource control signalling may be securely tunnelled between the said device and the relay.

In one embodiment, the mobile telecommunications network including a plurality of nodes and a network core, wherein a plurality of mobile telecommunications devices are registered with their network and communicate with the network core via the nodes, wherein at least one relay is provided between one of said nodes and one of said telecommunications devices to extend the radio coverage provided by the said node, wherein radio resource control, mobility management and session management signalling from said device is tunnelled between one of said relay nodes and a said node through the secure connection provided by said node to said relay, and wherein relay resource control signalling is also tunnelled between the relay and the said node.

In the embodiment to be described the mobile telecommunications network is an SAE/LTE cellular telecommunications network. The nodes are eNodeBs. However, the invention is applicable to other types of telecommunications networks, such as UMTS (3G) networks.

The relay may include means for attaching to the core network via the node such that the attaching procedure corresponds to that of one of the telecommunications devices. That is, the procedure performed when the relay attaches to the core network is substantially the same as the procedure when a mobile terminal attaches to the network such that it is transparent to said mobile device. In this way, relays can be provided without requiring extensive modification of the core network.

The node may be operable to provide securely the telecommunications device with an IP address as part of the attach procedure via the relay, or alternatively the core network may be operable to provide the telecommunications device with an IP address as part of the attach procedure via the relay.

One or more further relays may be provided in a communication path between the first mentioned relay and the node. The first mentioned relay is a “controlling relay” in the embodiment.

The present invention also provides a method of operating a mobile telecommunications network as defined in the claims.

The invention also relates to the methods of operating a telecommunications network disclosed.

### BRIEF DESCRIPTION OF THE DRAWINGS

For a better understanding of the present invention an embodiment will now be described by way of example with reference to the accompanying drawings in which:

FIG. 1 shows the elements of an SAE/LTE 4G network;

FIG. 2 shows the UE-eNodeB protocol stack;

FIG. 3 shows a known attach procedure;

FIG. 4 shows the radio coverage provided by cells of an eNodeB and relays, in accordance with the embodiment of the invention;

FIG. 5 shows the UE-eNodeB user plane; and

FIG. 6 shows the UE-eNodeB control interfaces;

FIG. 7 shows Relay Transport Control protocol between a controlling relay and an eNodeB;

FIG. 8 shows the tunnels established between UE, eNodeB and MME in an LTE/SAE communication system;

FIG. 9 shows the LTE access architecture when relays are employed;

FIG. 10 shows an alternative arrangement to that of FIG. 8;

FIG. 11 shows a first Attach procedure;

FIG. 12 shows a second Attach procedure;

FIG. 13 shows the procedure for adding a second-hop relay; and

FIG. 14 shows the UE security architecture.

In the drawings like elements are generally designated with the same reference sign.

### DETAILED DESCRIPTION OF EMBODIMENTS

### Overview of SAE/LTE Network

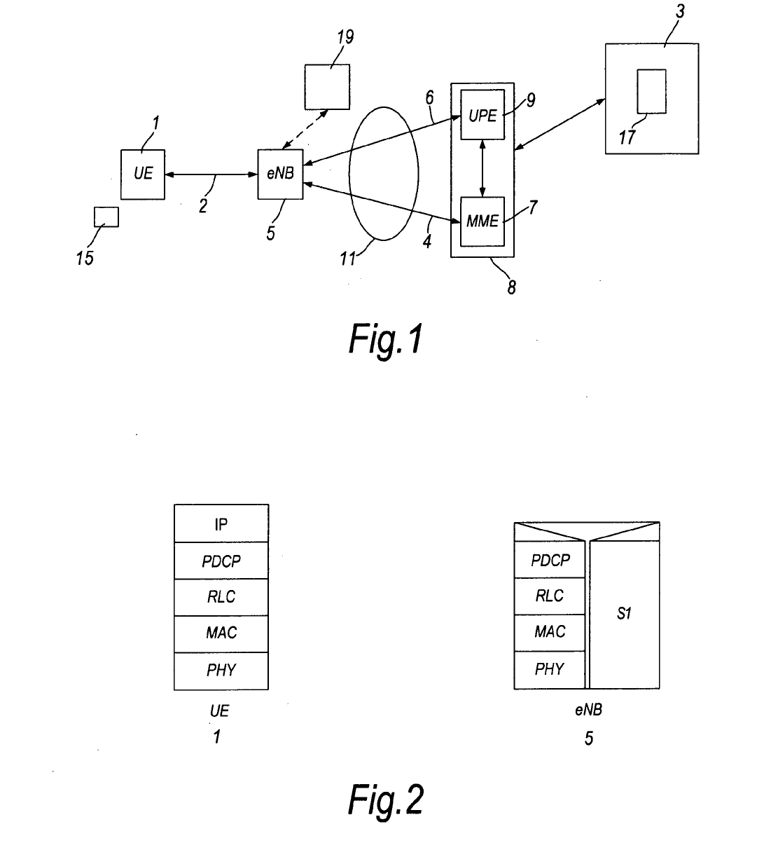

FIG. 1 shows schematically the logical elements of a SAE/LTE cellular telecommunications network. Mobile terminal (UE) 1 is registered with mobile telecommunications network core 3. The mobile terminal 1 may be a handheld mobile telephone, a personal digital assistant (PDA) or a laptop or desktop personal computer—for example, equipped with a wireless datacard. The device 1 communicates wirelessly with the mobile telecommunications network core 3 via the radio access network (RAN) of the mobile telecommunications network core 3 over radio interface 2. The RAN comprises an eNode 5. An eNode 5 performs functions generally similar to those performed by the nodeB and the radio network controller (RNC) of a 3G network. In practice there will be a multiplicity of eNodeBs 5, each serving a particular area or “cells”.

Signalling in a mobile telecommunications network can be considered to be separated into “control plane” signalling and “user plane signalling”. The control plane performs the required signalling, and includes the relevant application protocol and signalling bearer, for transporting the application protocol messages. Among other things, the application protocol is used for setting up the radio access bearer and the radio network layer. The user plane transmits data traffic and includes data streams and data bearers for the data streams. The data streams are characterised by one or more frame protocols specific for a particular interface. Generally speaking, the user plane carries data for use by a receiving terminal—such as data that allow a voice or picture to be reproduced—and the control plane controls how data are transmitted.

A PDP (packet data protocol) context defines parameters that support the flow of data traffic to and from a mobile terminal. Among the parameters that are set are the identifier of the external packet data network with which the terminal wishes to communicate, a PDP address recognised in that network (for example, the IP address allocated to the mobile terminal), the address of the network gateway, quality of service (QoS) parameters etc.

A mobility management entity (MME) 7 provides equivalent functions to the control plane functions of the SGSN and GGSN from the 3G architecture (Release-6). The MME handles security key management. The MME also provides control plane function for mobility between LTE and GSM/UMTS networks. Communications between the eNodeB 5 are transmitted to the MME 7 via the S1-c Interface 4.

A user plane entity (UPE) 9 handles the user plane traffic functions from the terminal 1 which includes the IP header and payload compression and ciphering. This UPE 9 provides the equivalent functions to the user plane part of the 3G RNC and the user plane part of the 3G GGSN. Communications between the eNodeB 5 are transmitted to the UPE 7 via the S1-u Interface 6. The known 3GPP authentication procedure may be re-used in the SAE/LTE architecture shown, between the terminal 1/UE and the MME 7.

It should be noted that, although in FIG. 1 the MME 7 and UPE 9 are shown as separate logical entities they may exist as a single physical node of the telecommunications network in gateway aGW 8.

Data are transmitted between the eNodeB 5 and the MME 7 and UPE 9 via IP transport network 11.

Although only one mobile terminal 1 is shown, there will in practice be a multiplicity of mobile terminals, each of which is registered with the network core 3. Each mobile terminal (including mobile terminal 1) is provided with a respective subscriber identity module (SIM) 15. During the manufacturing process of each SIM, authentication information is stored thereon under the control of the mobile telecommunications network core 3. The mobile telecommunications network core 3 itself stores details of each of the SIMs issued under its control. In operation of the mobile telecommunications network core 3, a terminal 1 is authenticated (for example, when the user activates the terminal in the network with a view to making or receiving calls) by the network sending a challenge to the terminal 1, incorporating a SIM 15, in response to which the SIM 15 calculates a reply and a key (dependent on the predetermined information held on the SIM—typically an authentication algorithm and a unique key Ki) and transmits the reply back to the mobile telecommunications network core 3. The mobile telecommunications network core 3 includes an authentication processor 17 which generates the challenge. Using information pre-stored concerning the content of the relevant SIM 15, the authentication processor 17 calculates the expected value of the reply from the mobile terminal 1 and the key. The authentication processor 17 sends the challenge, reply and key to the MME 7. The MME 7 sends the challenge to the mobile terminal 1. If the reply received by MME 7 matches the expected calculated reply, the SIM 15 and the associated mobile terminal 1 are considered to be authenticated. After the authentication process has been completed, the SIM 15 and MME 7 share a cipher key which can be used to protect subsequent communications. Integrity keys are generated and derived alongside the cipher keys. The integrity keys are used to integrity protect each of the secured links. The ciphering keys for each of the secured links are passed to the eNodeB 5, MME 7 and UPE 9.

It should be understood that such an authentication process can be performed for any terminal provided with a SIM 15 under control of the mobile telecommunications network core 3. Although the terminal 1 may communicate wirelessly with the mobile telecommunications network core 3 via the network's radio access network, this is not essential. For example, the terminal may communicate with the network via the fixed telephone network (PSTN), via a UMA access point, via WLAN and/or via the Internet.

If a USIM is used the authentication process is enhanced to provide the capability for the terminal to authenticate the network and to have assurance about the freshness of the key established as a result of the authentication process. In addition authentication using a USIM can generally be used to establish longer keys than if a SIM were used.

The SIM may also be a Universal Integrated Circuit Card (UICC).

The following abbreviations are used in the description:

| Term | Definition |
|---|---|
| 3RC | Relay Radio Resource Control |
| Cell ID | Cell Identity |
| Child Relay | The Relay which is the next hop towards the UE. |
| Controlling Relay | The Relay which is directly connected to the UE. |
| eNB | E-UTRAN Node B (Basestation, containing one or |
| | more cells, each with their own Cell ID) |
| Intermediary Relay | The Relay which is in the transmission path |
| | between a Relay and the eNB |
| LTE | Long Term Evolution |
| MRCF | Macro Resource Control Function |
| Parent Node | The Relay or eNB that is directly controlling |
| | this entity. |
| PDCP | Packet Data Convergence protocol |
| PDN | Packet Data Network |
| Relay Cluster | The tree of Relays (and their cells) which connect |
| | through a single cell hosted by an eNB. |
| RLC | Radio Link Control protocol |
| RRC | Radio Resource Control protocol |
| RRM | Radio Resource Management |
| RTC | Relay Transport Control |
| UE | User Equipment |
| X2 | X2 interface—The LTE interface which runs |
| | between eNBs |

FIG. 2 shows the UE-eNodeB protocol stack.

The eNB 5 hosts the PHYsical (PHY), Medium Access Control (MAC), Radio Link Control (RLC), and Packet Data Control Protocol (PDCP) layers that include the functionality of user-plane header-compression and encryption. The eNB 5 also provides Radio Resource Control (RRC) functionality corresponding to the control plane. The eNB 5 further provides many additional functions including radio resource management, admission control, scheduling, enforcement of negotiated uplink (UL) QoS, cell information broadcast, ciphering/deciphering of user and control plane data and compression/decompression of downlink (DL)/UL user plane packet headers.

In the control-plane, the RRC layer in the eNB 5 makes handover decisions based on neighbour cell measurements sent by the UE, pages for the UEs over the air, broadcasts system information, controls UE measurement reporting such as the periodicity of Channel Quality Information (CQI) reports and allocates cell-level temporary identifiers to active UEs. It also executes transfer of UE context from the source eNB to the target eNB during handover, and performs integrity protection of RRC messages. The RRC layer is responsible for the setting up and maintenance of radio bearers.

3GPP TS 23.401 (which is fully incorporated herein by reference), sub-clause 5.3.2.1, describes the initial attach procedure for a UE.

A UE 1/user needs to register with the network to receive services that require registration. This registration is described as Network Attachment. The always-on IP connectivity for UE 1/users of the EPS (Evolved Packet System) is enabled by establishing a default EPS bearer during Network Attachment. The PCC (Policy and Charging Control) rules applied to the default EPS bearer may be predefined in the PDN GW 50 and activated in the attachment by the PDN GW 50 itself. The Attach procedure may trigger one or multiple Dedicated Bearer Establishment procedures to establish dedicated EPS bearer(s) for that UE 1. During the attach procedure, the UE 1 may request for an IP address allocation. Terminals utilising only IETF based mechanisms for IP address allocation are also supported.

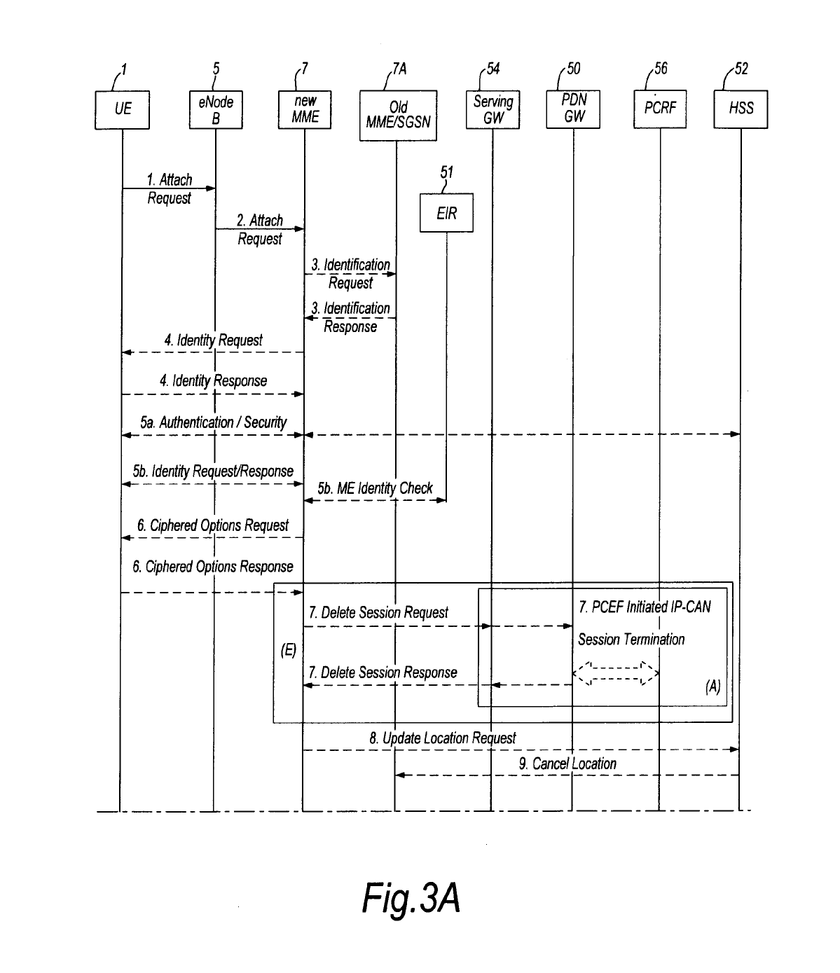

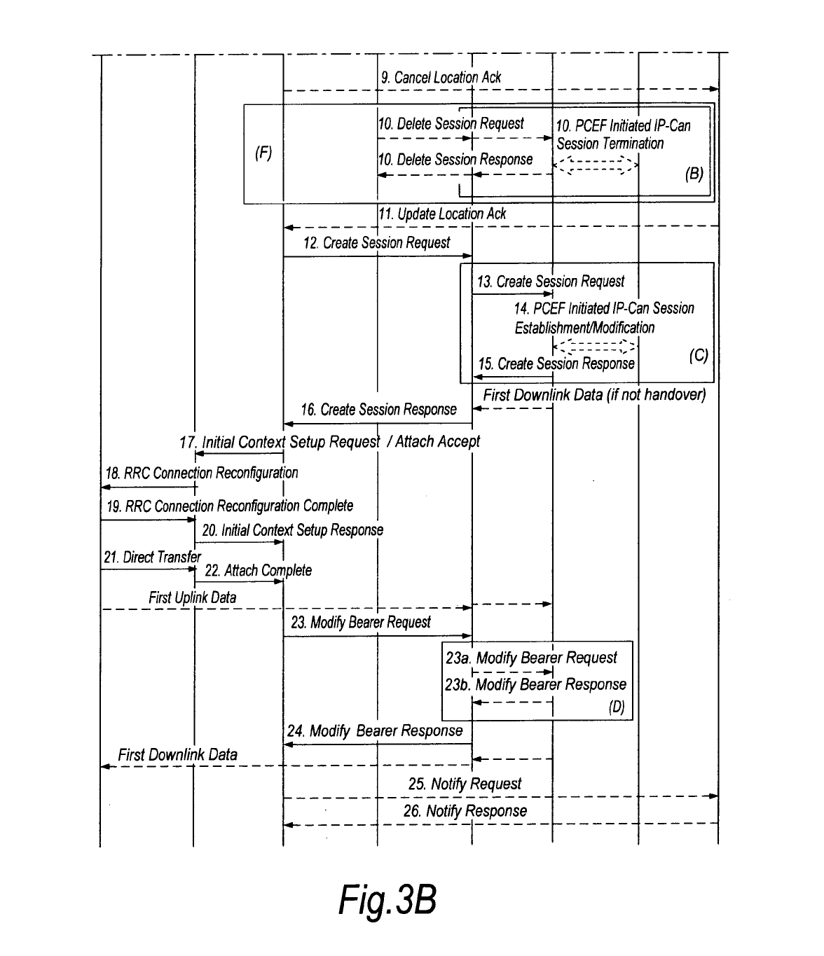

During the Initial Attach procedure the Mobile Equipment Identity is obtained from the UE 1. The MME operator may check the ME Identity with an EIR 51. At least in roaming situations, the MME 7 should pass the ME Identity to the HSS 52, and, if a PDN-GW 50 outside of the VPLMN, should pass the ME Identity to the PDN-GW 50.
NOTE 1: For a PMIP (Proxy Mobile IP)-based S5/S8, procedure steps (A), (B), and (C) are defined in TS 23.402 (which is fully incorporated herein by reference). Steps 7, 10, 13, 14, 15 and 23a/b concern GTP based S5/S8.
NOTE 2: The Serving GWs 54 and PDN GWs 50 involved in steps 7 and/or 10 may be different to those in steps 13-15.
NOTE 3: The steps in (D) are executed only upon handover from non-3GPP access.
NOTE 4: More detail on procedure steps (E) is defined in the procedure steps (B) in clause 5.3.8.3 of 3GPP TS 23.401.
NOTE 5: More detail on procedure steps (F) is defined in the procedure steps (B) in clause 5.3.8.4 of 3GPP TS 23.401.
1. The steps shown in FIG. 3 will now be described. The UE 1 initiates the Attach procedure by the transmission, to the eNodeB 5, of an Attach Request (IMSI or old GUTI (Globally Unique Temporary ID), last visited TAI (if available), UE Core Network Capability, UE Specific DRX parameters, PDN Type, Protocol Configuration Options, Ciphered Options Transfer Flag, Attach Type, KSI_{ASME}, NAS sequence number, NAS-MAC, additional GUTI, P-TMSI signature) message together with RRC parameters indicating the Selected Network and the old GUMMEI. The old GUTI may be derived from a P-TMSI and RAI. IMSI shall be included if the UE 1 does not have a valid GUTI or a valid P-TMSI available. The UE 1 stores the TIN in detached state. If the UE's TIN indicates “GUTI” or “RAT-related TMSI” and the UE 1 holds a valid GUTI then the old GUTI indicates this valid GUTI. If the UE's TIN indicates “P-TMSI” and the UE 1 holds a valid P-TMSI and related RAI then these two elements are indicated as the old GUTI. Mapping a P-TMSI and RAI to a GUTI is specified in TS 23.003. If the UE 1 holds a valid GUTI and the old GUTI indicates a GUTI mapped from a P-TMSI and RAI, then the UE indicates the GUTI as additional GUTI. If the old GUTI indicates a GUTI mapped from a P-TMSI and RAI and the UE 1 has a valid P-TMSI signature associated to it, the P-TMSI signature shall be included.
   If available, the last visited TAI shall be included in order to help the MME 7 produce a good list of TAIs for any subsequent Attach Accept message. Selected Network indicates the PLMN that is selected for network sharing purposes. The RRC parameter “old GUMMEI” takes its value from the “old GUTI” contained in the Attach Request. UE Network Capability is described in UE capabilities, see clause 5.11 of 3GPP TS 23.401.
   If the UE 1 has valid security parameters, the Attach Request message shall be integrity protected by the NAS-MAC in order to allow validation of the UE 1 by the MME 7. KSI_{ASME}, NAS sequence number and NAS-MAC are included if the UE 1 has valid EPS security parameters. NAS sequence number indicates the sequential number of the NAS message. If the UE 1 does not have a valid EPS security association, then the Attach Request message is not integrity protected. In this case the security association is established in step 5a. The UE 1 network capabilities indicate also the supported NAS and AS security algorithms. PDN type indicates the requested IP version (IPv4, IPv4/IPv6, IPv6). Protocol Configuration Options (PCO) are used to transfer parameters between the UE 1 and the PDN GW 50, and are sent transparently through the MME 7 and the Serving GW 54. The Protocol Configuration Options may include the Address Allocation Preference indicating that the UE 1 prefers to obtain an IPv4 address only after the default bearer activation by means of DHCPv4. If the UE 1 intends to send PCO which require ciphering (e.g., PAP/CHAP usernames and passwords) or send an APN, or both, the UE 1 shall set the Ciphered Options Transfer Flag and send PCO or APN or both only after authentication and NAS security setup have been completed (see below). If the UE 1 has UTRAN or GERAN capabilities, it should send the NRSU in the PCO to indicate the support of the network requested bearer control in UTRAN/GERAN. Attach Type indicates “Handover” when the UE 1 has already an activated PDN GW/HA due to mobility with non-3GPP accesses.
2. The eNodeB 5 derives the MME 7 from the RRC parameters carrying the old GUMMEI and the indicated Selected Network. If that MME 7 is not associated with the eNodeB 5 or the old GUMMEI is not available, the eNodeB 5 selects an MME 7 as described in clause 4.3.8.3 of 3GPP TS 23.401 on “MME selection function”. The eNodeB 5 forwards the Attach Request message to the new MME 7 contained in a S1-MME control message (Initial UE message) together with the Selected Network and TAI+ECGI of the cell from where it received the message to the new MME 7.
3. If the UE 1 identifies itself with GUTI and the MME 7 has changed since detach, the new MME 7 uses the GUTI received from the UE 1 to derive the old MME/SGSN address, and send an Identification Request (old GUTI, complete Attach Request message) to the old MME/SGSN 7A to request the IMSI. If the request is sent to an old MME 7A, the old MME 7A first verifies the Attach Request message by NAS MAC and then responds with Identification Response (IMSI, unused EPS Authentication Vectors, KSI_{ASME}, K_{ASME}). If the request is sent to an old SGSN, the old SGSN first verifies the Attach Request message by the P-TMSI signature and then responds with Identification Response (IMSI, Unused Authentication Quintets, CK, IK and KSI). If the UE 1 is not known in the old MME/SGSN 7A or if the integrity check or P-TMSI signature check for the Attach Request message fails, the old MME/SGSN 7A responds with an appropriate error cause.
   The additional GUTI in the Attach Request message allows the new MME 7 to find any already existing UE context stored in the new MME 7 when the old GUTI indicates a value mapped from a P-TMSI and RAI.
NOTE 6: A SGSN always responds with the UMTS security parameters and the MME 7 may store it for later use.
4. If the UE 1 is unknown in both the old MME/SGSN 7A and new MME 7, the new MME 7 sends an Identity Request to the UE 1 to request the IMSI. The UE 1 responds with Identity Response (IMSI).
5a If no UE context for the UE 1 exists anywhere in the network, if the Attach Request (sent in step 1) was not integrity protected, or if the check of the integrity failed, then authentication and NAS security setup to activate integrity protection and NAS ciphering are mandatory. Otherwise it is optional. If NAS security algorithm is to be changed, the NAS security setup is performed in this step. The authentication and NAS security setup functions are defined in clause 5.3.10 of 3GPP TS 23.401 on “Security Function”.
   After step 5a, all NAS messages shall be protected by the NAS security functions (integrity and ciphering) indicated by the MME 7.
5b. The ME Identity shall be retrieved from the UE 1. The ME identity shall be transferred encrypted. In order to minimise signalling delays, the retrieval of the ME Identity may be combined with NAS security setup in step 5a. The MME 7 may send the ME Identity Check Request (ME Identity, IMSI) to the EIR 51. The EIR 51 hall respond with ME Identity Check Ack (Result). Dependent upon the Result, the MME 7 decides whether to continue with this Attach procedure or to reject the UE 1.
6. If the UE 1 has set the Ciphered Options Transfer Flag in the Attach Request message, the Ciphered Options i.e. PCO or APN or both, shall now be retrieved from the UE 1.
   In order to handle situations where the UE 1 may have subscriptions to multiple PDNs, if the Protocol Configuration Options contains user credentials (e.g. user name/password within PAP or CHAP parameters) then the UE 1 should also send the APN to the MME 7.
7. If there are active bearer contexts in the new MME 7 for this particular UE (i.e. the UE re-attaches to the same MME 7 without having properly detached before), the new MME deletes these bearer contexts by sending Delete Session Request (TEIDs) messages to the GWs involved. The GWs acknowledge with Delete Session Response (TEIDs) message. If a PCRF is deployed, the PDN GW 50 employs an IP-CAN Session Termination procedure to indicate that resources have been released.
8. If the MME 7 has changed since the last detach, or if there is no valid subscription context for the UE 1 in the MME 7, or if the ME identity has changed, or if the UE provides an IMSI or the UE provides an old GUTI which does not refer to a valid context in the MME 7, the MME 7 sends an Update Location Request (MME Identity, IMSI, ME Identity, MME Capabilities, Update Type) message to the HSS 52. The MME 7 capabilities indicate the MME's support for regional access restrictions functionality. Update Type indicates this is Attach procedure.
9. The HSS52 sends Cancel Location (IMSI, Cancellation Type) to the old MME 7A. The old MME 7A acknowledges with Cancel Location Ack (IMSI) and removes the MM and bearer contexts. If the Update Type indicates Attach and the HSS 52 has the SGSN registration, then the HSS 52 sends Cancel Location (IMSI, Cancellation Type) to the old SGSN. The Cancellation Type indicates the old MME/SGSN 7A to release the old Serving GW resource.
10. If there are active bearer contexts in the old MME/SGSN 7A for this particular UE, the old MME/SGSN 7A deletes these bearer contexts by sending Delete Session Request (TEIDs) messages to the GWs involved. The GWs return Delete Session Response (TEIDs) message to the old MME/SGSN 7A. If a PCRF is deployed, the PDN GW 50 employs an IP-CAN Session Termination procedure as defined in TS 23.203 (which is fully incorporated herein by reference) to indicate that resources have been released.
11. The HSS 52 acknowledges the Update Location message by sending an Update Location Ack (IMSI, Subscription data) message to the new MME 7. The Subscription Data contain one or more PDN subscription contexts. Each PDN subscription context contains an ‘EPS subscribed QoS profile’ and the subscribed APN-AMBR (see clause 4.7.3). The new MME 7 validates the UE's presence in the (new) TA. If due to regional subscription restrictions or access restrictions the UE 1 is not allowed to attach in the TA or due to subscription checking fails for other reasons, the new MME 7 rejects the Attach Request with an appropriate cause and notifies the HSS 52 of the rejection (details of this notification is a stage 3 detail). If all checks are successful then the new MME constructs a context for the UE 1. If the APN provided by the UE 1 is not allowed by subscription, or the Update Location is rejected by the HSS 52, the new MME 7 rejects the Attach Request from the UE 1 with an appropriate cause.
12. If a subscribed PDN address is allocated for the UE 1 for this APN, the PDN subscription context contains the UE's IPv4 address and/or the IPv6 prefix and optionally the PDN GW 50 identity. In case the PDN subscription context contains a subscribed IPv4 address and/or IPv6 prefix, the MME 7 indicates it in the PDN address. For Attach Type indicating “Initial Attach”, if the UE 1 does not provide an APN, the MME 7 shall use the PDN GW 50 corresponding to the default APN for default bearer activation. If the UE 1 provides an APN, this APN shall be employed for default bearer activation. For Attach type indicating “Handover”, if the UE 1 provides an APN, the MME 7 shall use the PDN GW 50 corresponding to the provided APN for default bearer activation, If the UE 1 does not provide an APN, and the subscription context from HSS 52 contains a PDN GW identity corresponding to the default APN, the MME 7 shall use the PDN GW 50 corresponding to the default APN for default bearer activation. The case where the Attach type indicates “Handover” and the UE 1 does not provide an APN, and the subscription context from HSS 52 does not contain a PDN GW identity corresponding to the default APN constitutes an error case. If the attach type indicates “Initial Attach” and the selected PDN subscription context contains no PDN GW identity the new MME 7 selects a PDN GW 50 as described in clause 4.3.8.1 on PDN GW selection function (3GPP accesses). If the PDN subscription context contains a dynamically allocated PDN GW identity and the Attach Type does not indicate “Handover” the MME 7 may select a new PDN GW as described in clause PDN GW selection function, e.g. to allocate a PDN GW that allows for more efficient routing. The new MME selects a Serving GW 54 as described in clause 4.3.8.2 on Serving GW selection function and allocates an EPS Bearer Identity for the Default Bearer associated with the UE 1. Then it sends a Create Session Request (IMSI, MSISDN, MME TEID for control plane, PDN GW address, PDN Address, APN, RAT type, Default EPS Bearer QoS, PDN Type, APN-AMBR, EPS Bearer Identity, Protocol Configuration Options, Handover Indication, ME Identity, User Location Information (ECGI), MS Info Change Reporting support indication, Selection Mode, Charging Characteristics, Trace Reference, Trace Type, Trigger Id, OMC Identity, Maximum APN Restriction, Dual Address Bearer Flag, the Protocol Type over S5/S8) message to the selected Serving GW 54.
   The RAT type is provided in this message for the later PCC decision. The subscribed APN-AMBR for the APN is also provided in this message. The MSISDN is included if provided in the subscription data from the HSS 52. Handover Indication is included if the Attach type indicates handover. Selection Mode indicates whether a subscribed APN was selected, or a non-subscribed APN sent by the UE 1 was selected. Charging Characteristics indicates which kind of charging the bearer context is liable for. The MME 7 may change the requested PDN type according to the subscription data for this APN as described in clause 5.3.1.1. The MME 7 shall set the Dual Address Bearer Flag when the PDN type is set to IPv4v6 and all SGSNs which the UE 1 may be handed over to are Release 8 or above supporting dual addressing, which is determined based on node pre-configuration by the operator. The Protocol Type over S5/S8 is provided to Serving GW which protocol should be used over S5/S8 interface.
   The charging characteristics for the PS subscription and individually subscribed APNs as well as the way of handling Charging Characteristics and whether to send them or not to the P-GW is defined in TS 32.251 (which is fully incorporated herein by reference). The MME 7 shall include Trace Reference, Trace Type, Trigger Id, and OMC Identity if S-GW and/or P-GW trace is activated. The MME 7 shall copy Trace Reference, Trace Type, and OMC Identity from the trace information received from the HLR or OMC.
   The Maximum APN Restriction denotes the most stringent restriction as required by any already active bearer context. If there are no already active bearer contexts, this value is set to the least restrictive type (see clause 15.4 of TS 23.060 (which is fully incorporated herein by reference). If the P-GW 50 receives the Maximum APN Restriction, then the P-GW 50 shall check if the Maximum APN Restriction value does not conflict with the APN Restriction value associated with this bearer context request. If there is no conflict the request shall be allowed, otherwise the request shall be rejected with sending an appropriate error cause to the UE 1.
NOTE 7: The Dual Address Bearer Flag is not used when the Protocol Type over S5/S8 is PMIP.
13. The Serving GW 54 creates a new entry in its EPS Bearer table and sends a Create Session Request (IMSI, MS ISDN, APN, Serving GW Address for the user plane, Serving GW TEID of the user plane, Serving GW TEID of the control plane, RAT type, Default EPS Bearer QoS, PDN Type, PDN Address, subscribed APN-AMBR, EPS Bearer Identity, Protocol Configuration Options, Handover Indication, ME Identity, User Location Information (ECGI), MS Info Change Reporting support indication, Selection Mode, Charging Characteristics, Trace Reference, Trace Type, Trigger Id, OMC Identity, Maximum APN Restriction, Dual Address Bearer Flag) message to the PDN GW 50 indicated by the PDN GW address received in the previous step. After this step, the Serving GW 54 buffers any downlink packets it may receive from the PDN GW 50 without sending a Downlink Data Notification message to the MME 7 until it receives the Modify Bearer Request message in step 23 below. The MSISDN is included if received from the MME 7.
14. If dynamic PCC is deployed and the Handover Indication is not present, the PDN GW 50 performs an IP-CAN Session Establishment procedure as defined in TS 23.203, and thereby obtains the default PCC rules for the UE 1. This may lead to the establishment of a number of dedicated bearers following the procedures defined in clause 5.4.1 in association with the establishment of the default bearer.
   The IMSI, UE IP address, User Location Information (ECGI), Serving Network, RAT type, APN-AMBR, Default EPS Bearer QoS are provided to the PCRF PCC Rules Function 56 by the PDN GW 50 if received by the previous message. The User Location Information is used for location based charging.
   The PCRF 56 may modify the APN-AMBR and the QoS parameters (QCI and ARP) associated with the default bearer in the response to the PDN GW as defined in TS 23.203.
NOTE 8: While the PDN GW50/PCEF may be configured to activate predefined PCC rules for the default bearer, the interaction with the PCRF 56 is still required to provide e.g. the UE IP address information to the PCRF 56.
NOTE 9: If the IP address is not available when the PDN GW 50 performs the IP-CAN Session Establishment procedure with the PCRF 56, the PDN GW 50 initiates an IP-CAN Session Modification procedure to inform the PCRF 56 about an allocated IP address as soon as the address is available. In this version of the specification, this is applicable only to IPv4 address allocation.
   If dynamic PCC is deployed and the Handover Indication is present, the PDN GW 50 executes a PCEF 56 Initiated IP-CAN Session Modification procedure with the PCRF 56 as specified in TS 23.203 to report the new IP-CAN type. Depending on the active PCC rules, the establishment of dedicated bearers for the UE 1 may be required. The establishment of those bearers shall take place in combination with the default bearer activation. This procedure can continue without waiting for a PCRF response. If changes to the active PCC rules are required, the PCRF 56 may provide them after the handover procedure is finished.
   In both cases (Handover Indication is present or not), if dynamic PCC is not deployed, the PDN GW 50 may apply local QoS policy. This may lead to the establishment of a number of dedicated bearers for the UE following the procedures defined in clause 5.4.1 in combination with the establishment of the default bearer.
15. The P-GW 50 creates a new entry in its EPS bearer context table and generates a Charging Id. The new entry allows the P-GW 50 to route user plane PDUs between the S-GW 54 and the packet data network, and to start charging. The way the P-GW 50 handles Charging Characteristics that it may have received is defined in TS 32.251 (which is fully incorporated herein by reference).
   The PDN GW 50 returns a Create Session Response (PDN GW Address for the user plane, PDN GW TEID of the user plane, PDN GW TEID of the control plane, PDN Type, PDN Address, EPS Bearer Identity, EPS Bearer QoS, Protocol Configuration Options, Charging Id, Prohibit Payload Compression, APN Restriction, Cause, MS Info Change Reporting Action (Start) (if the PDN GW 50 decides to receive UE's location information during the session), APN-AMBR) message to the Serving GW 54. The PDN GW 50 takes into account the received PDN type, the Dual Address Bearer Flag and the policies of operator when the PDN GW 50 selects the PDN type to be used as follows. If the received PDN type is IPv4v6 and both IPv4 and IPv6 addressing is possible in the PDN but the Dual Address Bearer Flag is not set, or only single IP version addressing for this APN is possible in the PDN, the PDN GW 50 selects a single IP version (either IPv4 or IPv6). If the received PDN type is IPv4 or IPv6, the PDN GW 50 uses the received PDN type if it is supported in the PDN, otherwise an appropriate error cause will be returned. The PDN GW 50 allocates a PDN Address according to the selected PDN type. If the PDN GW has selected a PDN type different from the received PDN Type, the PDN GW indicates together with the PDN type IE a reason cause to the UE why the PDN type has been modified, as described in clause 5.3.1.1. PDN Address may contain an IPv4 address for IPv4 and/or an IPv6 prefix and an Interface Identifier. If the PDN has been configured by the operator so that the PDN addresses for the requested APN shall be allocated by usage of DHCPv4 only, or if the PDN GW 50 allows the UE 1 to use DHCPv4 for address allocation according to the Address Allocation Preference received from the UE 1, the PDN Address shall be set to 0.0.0.0, indicating that the IPv4 PDN address shall be negotiated by the UE with DHCPv4 after completion of the Default Bearer Activation procedure. In case of external PDN addressing for IPv6, the PDN GW 50 obtains the IPv6 prefix from the external PDN using either RADIUS or Diameter client function. In the PDN Address field of the Create Session Response, the PDN GW 50 includes the Interface Identifier and IPv6 prefix. The PDN GW 50 sends Router Advertisement to the UE 1 after default bearer establishment with the IPv6 prefix information for all cases.
   If the PDN address is contained in the Create Session Request, the PDN GW 50 shall allocate the IPv4 address and/or IPv6 prefix contained in the PDN address to the UE 1. The IP address allocation details are described in clause 5.3.1 on “IP Address Allocation”. The PDN GW 50 derives the BCM based on the NRSU and operator policy. Protocol Configuration Options contains the BCM as well as optional PDN parameters that the P-GW 50 may transfer to the UE 1. These optional PDN parameters may be requested by the UE 1, or may be sent unsolicited by the P-GW 50. Protocol Configuration Options are sent transparently through the MME 7.
   When the Handover Indication is present, the PDN GW 50 does not yet send downlink packets to the S-GW54; the downlink path is to be switched at step 23a.
16. If the MS Info Change Reporting Action (Start) is received for this bearer context, then the S-GW 54 shall store this for the bearer context and the S-GW 54 shall report to that P-GW 50 whenever a UE's location change occurs that meets the P-GW request, as described in clause 15.1.1a of TS 23.060[7].
   The Serving GW 54 returns a Create Session Response (PDN Type, PDN Address, Serving GW address for User Plane, Serving GW TEID for User Plane, Serving GW TEID for control plane, EPS Bearer Identity, EPS Bearer QoS, PDN GW addresses and TEIDs (GTP-based S5/S8) or GRE keys (PMIP-based S5/S8) at the PDN GW(s) for uplink traffic, Protocol Configuration Options, Charging Id, Prohibit Payload Compression, APN Restriction, Cause, MS Info Change Reporting Action (Start), APN-AMBR) message to the new MME 7.
17. If an APN Restriction is received, then the MME 7 shall store this value for the Bearer Context and the MME 7 shall check this received value with the stored value for the Maximum APN Restriction to ensure there are no conflicts between values. If the Bearer Context is accepted, the MME 7 shall determine a (new) value for the Maximum APN Restriction. If there is no previously stored value for Maximum APN Restriction, then the Maximum APN Restriction shall be set to the value of the received APN Restriction.
   If the MS Info Change Reporting Action (Start) is received for this bearer context, then the MME 7 shall store this for the bearer context and the MME 7 shall report whenever a UE's location change occurs that meets the request, as described in clause 15.1.1a of TS 23.060.
   The MME 7 determines the UE AMBR to be used by the eNB5 based on the subscribed UE-AMBR and the APN-AMBR for the default APN, see clause 4.7.3.
   The new MME 7 sends an Attach Accept (APN, GUTI, PDN Type, PDN Address, TAI List, EPS Bearer Identity, Session Management Request, Protocol Configuration Options, KSI_{ASME}, NAS sequence number, NAS-MAC, IMS Voice over PS session supported Indication) message to the eNodeB 5. GUTI is included if the new MME 7 allocates a new GUTI. This message is contained in an S1_MME control message Initial Context Setup Request. This S1 control message also includes the AS security context information for the UE, the Handover Restriction List, the EPS Bearer QoS, the UE-AMBR, EPS Bearer Identity, as well as the TEID at the Serving GW 54 used for user plane and the address of the Serving GW 54 for user plane. In the Attach Accept message, the MME 7 does not include the IPv6 prefix within the PDN Address. The MME 7 includes the EPS Bearer QoS parameter QCI and APN-AMBR into the Session Management Request. Furthermore, if the UE 1 has UTRAN or GERAN capabilities, the MME 7 uses the EPS bearer QoS information to derive the corresponding PDP context parameters QoS Negotiated (R99 QoS profile), Radio Priority, Packet Flow Id and TI and includes them in the Session Management Request. If the UE 1 indicated in the UE 1 Network Capability it does not support BSS packet flow procedures, then the MME 7 shall not include the Packet Flow Id. Handover Restriction List is described in clause 4.3.5.7 “Mobility Restrictions”. The MME 7 sets the IMS Voice over PS session supported Indication as described in clause 4.3.5.8.
   If the MME 7 or PDN GW 50 has changed the PDN Type, an appropriate reason cause shall be returned to the UE 1 as described in clause 5.3.1.1.
18. The eNodeB 5 sends the RRC Connection Reconfiguration message including the EPS Radio Bearer Identity to the UE 1, and the Attach Accept message will be sent along to the UE 1. The UE 1 shall store the QoS Negotiated, Radio Priority, Packet Flow Id and TI, which it received in the Session Management Request, for use when accessing via GERAN or UTRAN. The APN is provided to the UE 1 to notify it of the APN for which the activated default bearer is associated. Further details are in TS 36.331 (which is fully incorporated herein by reference). The UE 1 may provide EPS Bearer QoS parameters to the application handling the traffic flow(s). The application usage of the EPS Bearer QoS is implementation dependent. The UE 1 shall not reject the RRC Connection Reconfiguration on the basis of the EPS Bearer QoS parameters contained in the Session Management Request.
   When receiving the Attach Accept message the UE 1 shall set its TIN to “GUTI” as no ISR Activated is indicated.
   If the UE 1 receives an IPv4 address set to 0.0.0.0, it may negotiate the IPv4 address with DHCPv4 as specified in TS 29.061 (which is fully incorporated herein by reference). If the UE 1 receives an IPv6 interface identifier, it may wait for the Router Advertisement from the network with the IPv6 prefix information or it may send a Router Solicitation if necessary.
NOTE 10: The IP address allocation details are described in clause 5.3.1 on “IP Address Allocation”.
19. The UE 1 sends the RRC Connection Reconfiguration Complete message to the eNodeB 5. For further details, see TS 36.331 (which is fully incorporated herein by reference).
20. The eNodeB 5 sends the Initial Context Response message to the new MME 7. This Initial Context Response message includes the TEID of the eNodeB 5 and the address of the eNodeB 5 used for downlink traffic on the S1_U reference point.
21. The UE 1 sends a Direct Transfer message to the eNodeB 5, which includes the Attach Complete (EPS Bearer Identity, NAS sequence number, NAS-MAC) message.
22. The eNodeB 5 forwards the Attach Complete message to the new MME 7 in an Uplink NAS Transport message.
   After the Attach Accept message and once the UE 1 has obtained a PDN Address, the UE 1 can then send uplink packets towards the eNodeB 5 which will then be tunnelled to the Serving GW 54 and PDN GW 50. If the UE 1 requested for a dual address PDN type (IPv4v6) to a given APN and was granted a single address PDN type (IPv4 or IPv6) by the network with a reason cause indicating that only single IP version per PDN connection is allowed sent together with the PDN type, the UE 1 may request for the activation of a parallel PDN connection to the same APN with a single address PDN type (IPv4 or IPv6) other than the one already activated. If the UE 1 receives no reason cause in step 18 in response to an IPv4v6 PDN type and it receives an IPv6 Interface Identifier apart from the IPv4 address or 0.0.0.0 in the PDN Address field, it considers that the request for a dual address PDN was successful. It can wait for the Router Advertisement from the network with the IPv6 prefix information or it may send Router Solicitation if necessary.
23. Upon reception of both, the Initial Context Response message in step 21 and the Attach Complete message in step 22, the new MME 7 sends a Modify Bearer Request (EPS Bearer Identity, eNodeB address, eNodeB TEID, Handover Indication) message to the Serving GW 54.
23a. If the Handover Indication is included in step 23, the Serving GW 54 sends a Modify Bearer Request (Handover Indication) message to the PDN GW 50 to prompt the PDN GW 50 to tunnel packets from non 3GPP IP access to 3GPP access system and immediately start routing packets to the Serving GW 54 for the default and any dedicated EPS bearers established.
23b. The PDN GW 50 acknowledges by sending Modify Bearer Response to the Serving GW 56.
24. The Serving GW 56 acknowledges by sending Modify Bearer Response (EPS Bearer Identity) message to the new MME 7. The Serving GW 56 can then send its buffered downlink packets.
25. After the MME 7 receives Modify Bearer Response (EPS Bearer Identity) message, if Attach type does not indicate handover and an EPS bearer was established and the subscription data indicates that the user is allowed to perform handover to non-3GPP accesses, and if the MME 7 selected a PDN GW that is different from the PDN GW identity which was indicated by the HSS 52 in the PDN subscription context, the MME 7 shall send a Notify Request including the APN and PDN GW identity to the HSS 52 for mobility with non-3GPP accesses.
26. The HSS 52 stores the APN and PDN GW 50 identity pair and sends a Notify Response to the MME 7.
NOTE 11: For handover from non-3GPP access, the PDN GW 50 initiates resource allocation deactivation procedure in the trusted/untrusted non-3GPP IP access as specified in TS 23.402.

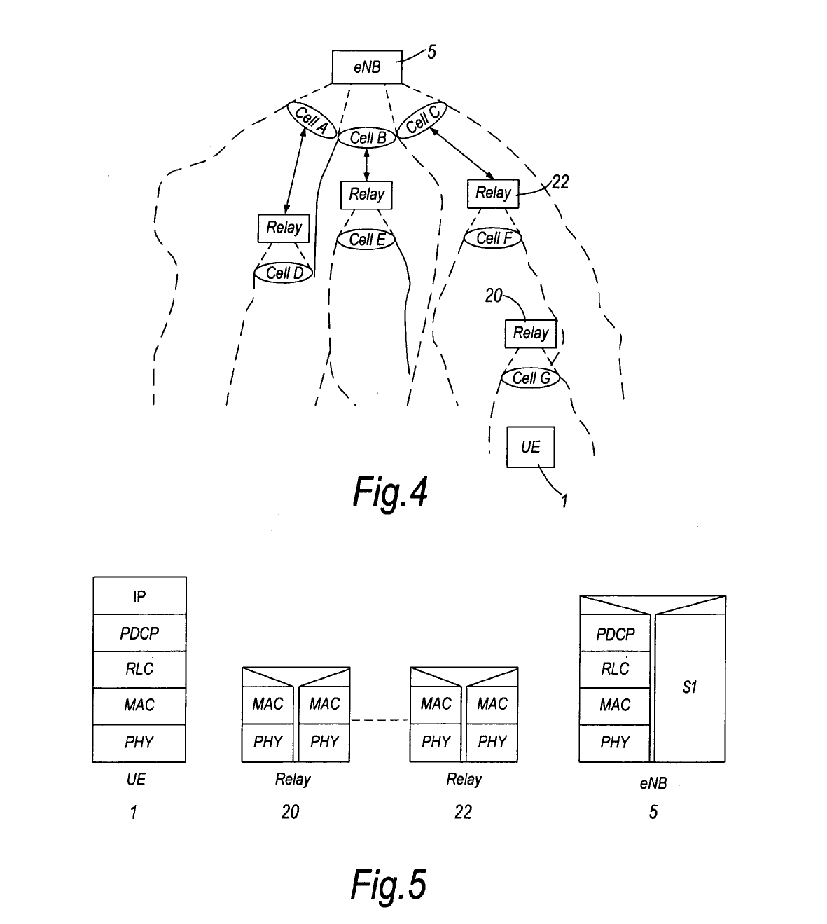

FIG. 4 shows the radio coverage provided by cell A, cell B and cell C of an eNodeB 5. In order to improve the coverage provided by the eNodeB 5 one or more relays may be used to provide additional cells D, E, F and G. To a UE a relay has the same “appearance” as a cell. However, the relay has a unique cell ID, different from the cell ID of the eNodeB 5 cell that the relay connects through, and performs unique system information transmission to the UE. Similarly, the relay “appears” to the eNodeB 5 as a UE.

One or more relays may be provided in the communication path between the UE 1 and the eNodeB 5 (relays 20 and 22 in FIG. 4). The relay 20 closest to the UE 1 in the communication path is a “controlling relay”. Advantageously, the number of relays in the communication path between a UE 1 and an eNodeB 5 is scaleable. The design of a relay is the same when it is connected directly to the eNodeB 5 and when it is connected to another relay in the communication path between the eNodeB 5 and the UE 1. The relays are arranged in a tree structure.

Advantageously, the present embodiment seeks to preserve the security conventionally provided between the UE and the eNodeB. The security architecture can be split into:
(1) the relay security architecture, which in this case is the control protocols used between the relays, and between the relay and the eNode B such that the UE security architecture can be predominantly reused for the relay security architecture and security management in the core network; and
(2) the UE security architecture, which is the adaptation of the existing LTE security architecture for use in the relays by extending the UE security architecture over the secure connection between the eNodeBs and controlling-relay.

FIG. 5 shows a first relay 20 and a second relay 22 in the communication path between the UE 1 and the eNodeB 5. In the UE-eNodeB user plane, the main characteristics of the user plane design are:
The buffer status reporting and scheduling completed on a hop-by-hop basis, controlled by the parent node such that resources are shared between users based on available payload, and relative radio conditions of each link to maximize system throughput.
H-ARQ terminated on each hop such that the link throughput can be maximized based on the instantaneous radio quality on the link.
The RLC-SDU is passed complete to the next hop by the relays to maintain security from eNodeB to UE. The ciphering for the UE user plane runs between the UE and the eNB, transparently over the Relays.

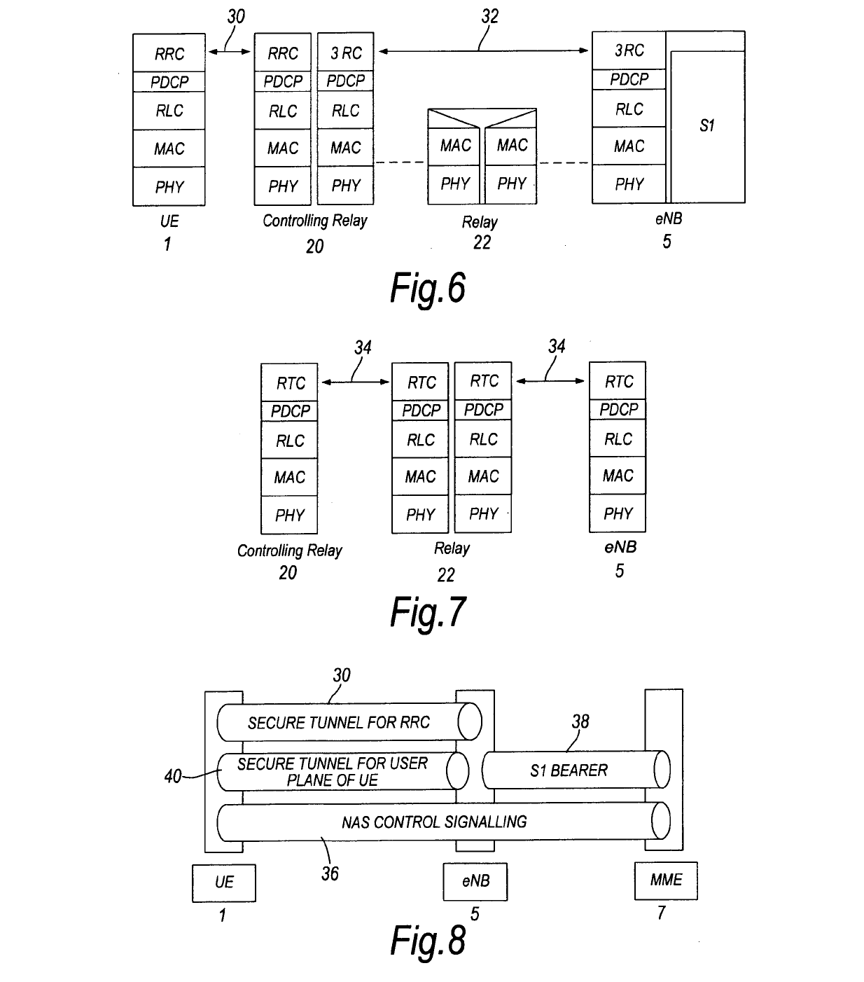

FIG. 6 shows the UE-eNodeB control interfaces. The RRC 30, including its ciphering and integrity protection, runs between the UE and the controlling relay. The RRC signalling for the UE, such as handover messaging, is tunnelled between the controlling relay 20 and the Multimedia Resource Control Function (MRCF) in the eNodeB 5 using a new protocol, referred to hereinafter as 3RC protocol 32. The 3RC protocol passes UE specific signalling directly from the controlling relay 20 to the eNodeB 5 where it can be routed to the correct destination, either along the S2 interface or S1 interface. The 3RC protocol is also used by the eNodeB 5 to configure the controlling relay 20.

The intermediary 22 relay in FIG. 6 only performs the routing of the RLC packets between the eNodeB 5 in the controlling relay 20. The PDCP frames are ciphered between the eNodeB 5 and the controlling relay 20. This uses the ciphering key defined for the controlling relay's user plane. The 3RC protocol may include a MAC field for integrity protection.

In FIG. 6 the security between the UE 1 and the controlling relay 20 is the same as the security between the UE 1 and the eNodeB 5. The embodiment provides the 3RC protocol between the controlling relay 20 and the eNodeB 5 to facilitate tunnelling of RRC signalling between the controlling relay 20 and the eNodeB 5.

In FIG. 6 only the RRC layer is modified compared to the conventional protocol stack. The PDCP, RLC, MAC and PHY layers are the same, and operate in the same way, as if the eNodeB 5 communicated directly with the UE 1.

FIG. 7 shows the relay transport protocol according to the embodiment. A Relay Transport Control (RTC) protocol 34 is provided to establish transport links between a relay and its parent node (eNodeB 5), and to remove the transport links when they are no longer required. The protocol uses some aspects of RRC, particularly with respect to the initial access procedure, which initiates the connection of the relay to its parent. The RTC protocol is also used to pass batched buffer status reporting to the next hop node if required, such that the radio resources can be targeted to the link where it is most needed due to challenging radio conditions and/or greater demand. The link is ciphered and integrity protected using the keys defined for the RRC of the relay, and runs from the relay to its parent node.

In the conventional LTE system Non-Access Stratum (NAS) signalling is passed between the MME 7 and the UE 1. The NAS signalling generates and allocates temporary identities to the UEs. It also checks authorisation of the UE to camp on a service provider's PLMN and enforces UE roaming restrictions. The MME 7 is the termination point for ciphering/integrity protection for NAS signalling. In the control plane, the NAS protocol is used for control purposes such as network attach, authentication, setting up of bearers and mobility management. All NAS messages are ciphered and integrity key protected by the MME 7 and UE 1.

As shown in FIG. 8 conventionally NAS control signalling is tunnelled at 36 between the MME 7 and the UE 1. A secure RRC tunnel 30 is established between the eNodeB 5 and the UE 1. An S1 bearer 38 passes data between the MME 7 and the eNodeB. A secure channel 40 is established between the eNodeB 5 and the UE 1 for the user plane of the UE 1.

With the introduction of relays in the LTE access architecture some modification to the conventional eNodeB system is necessary; however, according to the embodiment, the modifications will cause no impact to legacy LTE UEs.

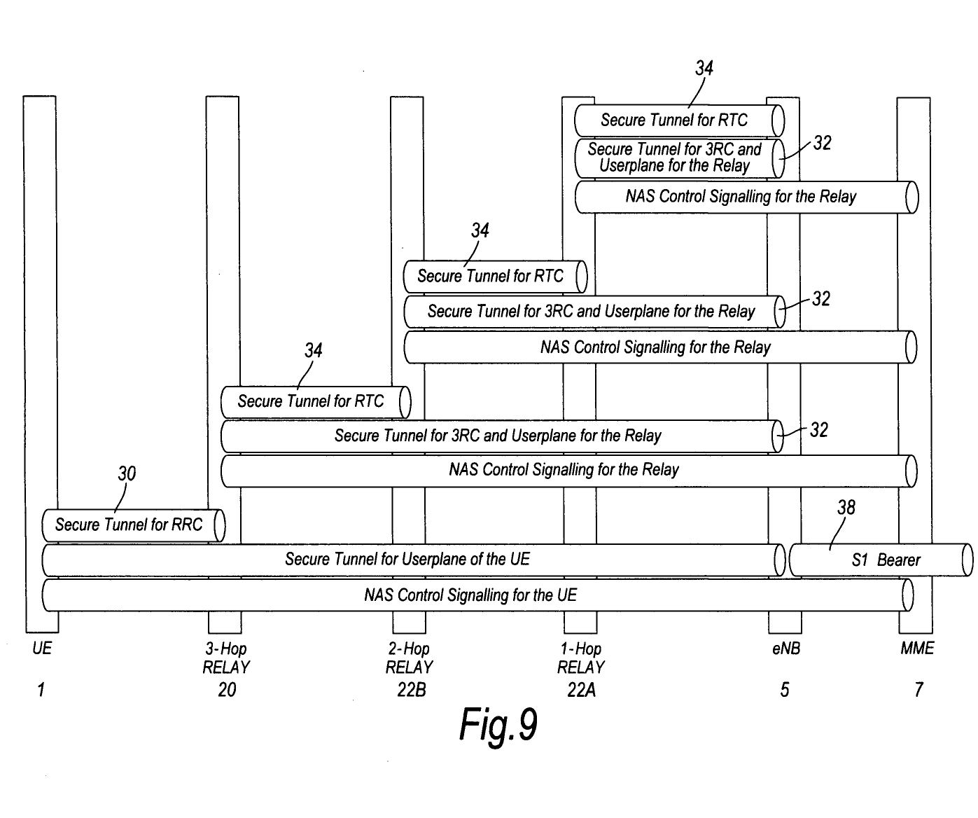

As shown in FIG. 9, the conventional architecture is modified by moving the RRM function and RRC tunnel 30 termination from the eNodeB 5 to the controlling relay 20. The eNodeB 5 maintains the functionality required to manage the interactions between the neighbour cells, such as MME 7 load balancing, inter eNodeB load balancing handovers, X2 interfaces and inter-cell interference coordination, as well as high level resource allocation for the relays parented by the eNodeB 5 (that is, the relays that have the eNodeB at the route of their tree).

With such an arrangement, the termination point for the RRC protocol (and the PDCP/RLC protocols used for the transport of the RRC protocol) is moved to the controlling relay 20 from the eNodeB 5. A new RRC protocol runs between the eNodeB 5 and the controlling relay 20 to transport information from the two parts 32,34 (which are the 3RC and RTC protocols) of the RRM.

The RTC protocol 34 between the relay and its parent node is used to add and remove entities from the tree as well as performing resource allocation in a similar way to that defined for RRC.

The new 3RC protocol 32 is a logical connection between a relay and eNodeB 5, and this is used to allow control messages to be passed directly between the relay and the eNodeB 5. The UE/relay context is stored at the controlling relay 20, including the RRC/RTC cipher key. The cipher key is securely tunnelled directly to the controlling relay 20, and intermediary relays cannot see the content of this tunnel. The NAS messages from the UE 1 are passed over the air in the RRC tunnel 30 to the controlling relay 20 and are then routed down the 3RC tunnels 32 between the controlling relay 20 and the eNodeB 5 in a secure manner.

In the FIG. 9 embodiment an important aspect is the formation of a hop-by-hop secure link between the eNodeB 5 and the first hop relay 22A, between the controlling relay 20 and the UE 1 and between each of the intermediary relays 22B. This provides a scaleable solution. The solution is independent upon the number of hops and number of relays present in the tree.

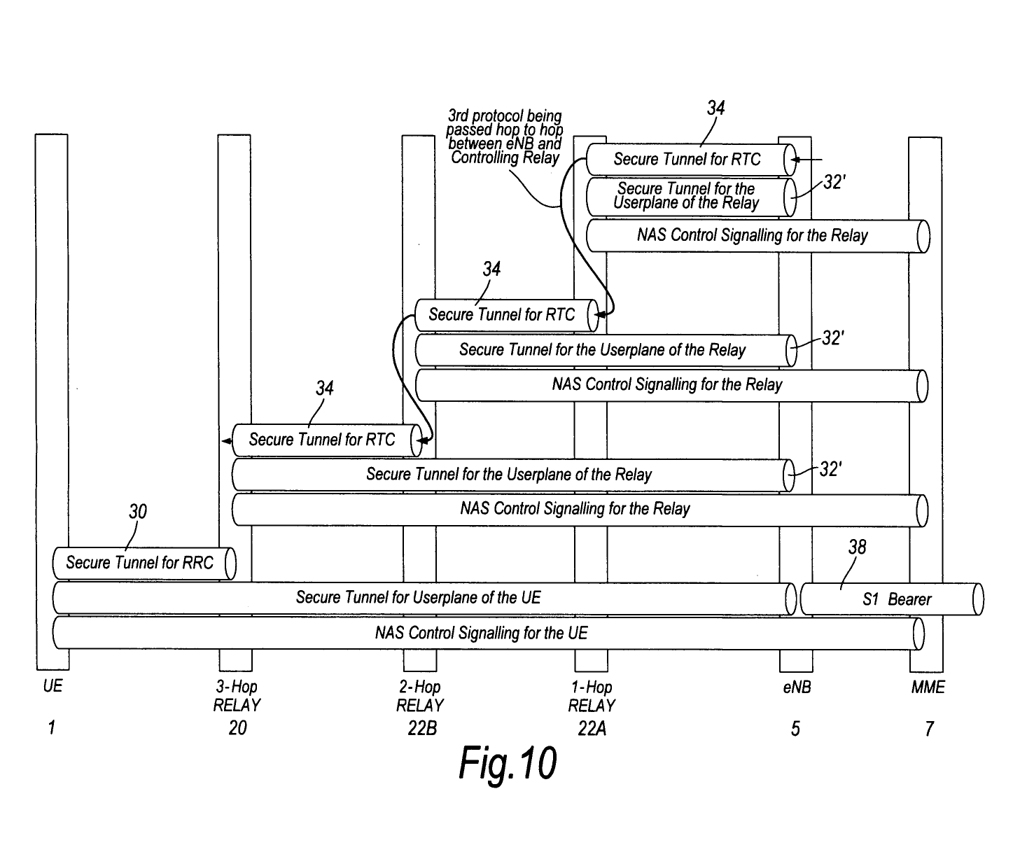

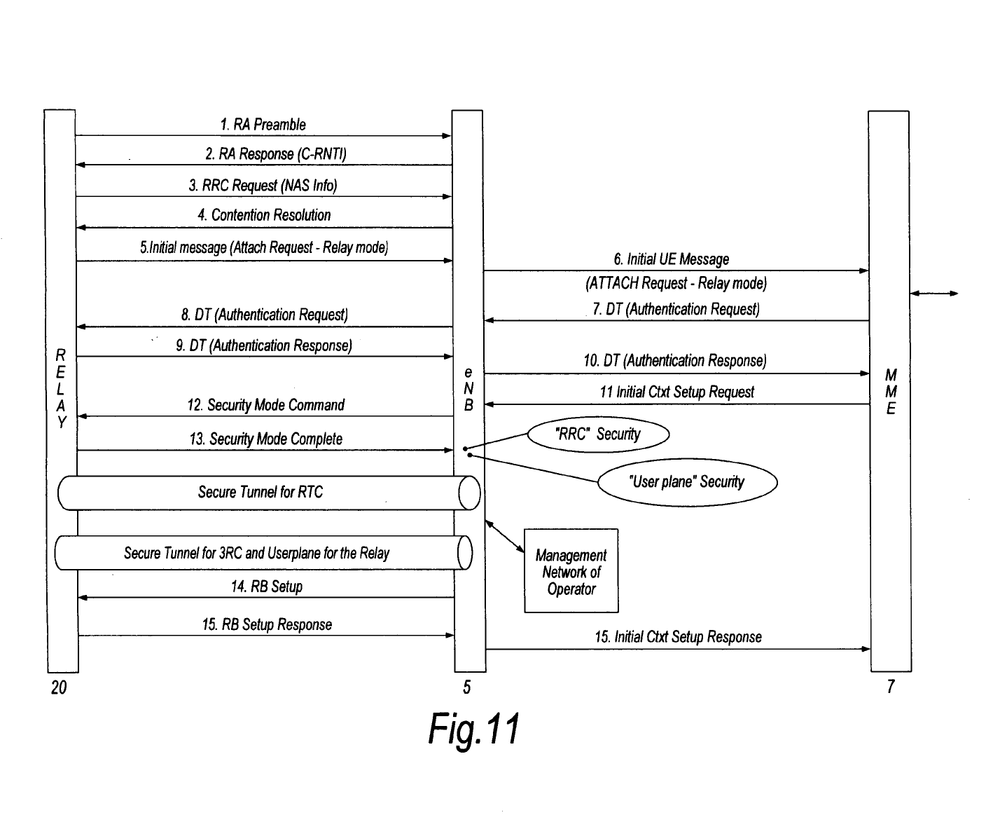

FIG. 10 shows an alternative arrangement in which the 3RC protocol is part of the RTC protocol 34, with communications between the eNodeB and the controlling relay being passed hop-by-hop.

The user plane tunnels for each relay are terminated at the eNode B 5, and the eNodeB 5 acts as an IP router/firewall only allowing connectivity to the relay from the network management entities of the operator.

Conventionally in LTE security (for example, ciphering) for the RRC protocol and user plane runs between the UE 1 and the eNodeB 5, and the security (for example, ciphering and integrity protection) for the NAS control protocol runs between the UE 1 and the MME 7. In the embodiments, the modifications made to this base architecture require that the security architecture for the access would need to be modified. However, this modification of the RRC termination is transparent to the UE 1, and therefore allows the embodiment to operate with legacy UEs.

### Relay Security Architecture

The Relay Security Architecture is split into:
Securing of Relay Admission into Relay Cluster
Securing of Transport between Relay and Parent node
Securing of Transport between Controlling Relay to eNB
   Admission of a Relay into a Relay Cluster

### First-hop Relay

In the embodiment the Relay contains a USIM/UICC card. To minimise costs, the Relay architecture is based as much as possible on the LTE architecture.

When a Relay is attached to the Relay Cluster, it attempts to connect to its Parent Node (eNodeB 5) using the initial access procedure defined for any UE—defined in 3GPP TS 23.401, sub-clause 5.3.2.1, and as described above in relation to FIG. 3. If this is the first Relay it will connect directly to the eNB 5, and the eNB 5 need not distinguish between it and a normal UE during the initial access.

When the UE conventionally performs the Initial Access procedure it creates an RRC connection between the UE and the eNB. When the Relay performs the Initial Access procedure it creates an RTC connection between the Relay and its parent node. The RTC connection is similar in many respects to the RRC connection; however, it also includes functionality specific to relay operation, e.g. management of packet routing.

Depending on the requirement for IP connectivity of the Relay, the Attach procedure may be completed in one of two ways:

Solution 1—Local IP Connectivity Required to be Provided by eNodeB—FIG. 11

In the ATTACH message [step 5] (of the NAS Control Protocol) the Relay indicates that it wishes to attach in RELAY mode, this indication is passed up to the MME 7 [step 6], and the MME 7 verifies that this subscription (associated with the USIM card in the Relay) is allowed to be used for a Relay. This indication could be used by the MME 7 to know not to allocate S1 interface connectivity for this Relay, and to avoid allocation of a Serving Gateway and PDN Gateway (which would occur if a UE was performing the Attach procedure). When the Attach message indicates “Relay mode”, the MME 7 also does not allocate an IP address to the connecting entity (i.e. the Relay).

In the same manner as a UE, the Relay uses Dynamic Host Configuration Protocol (DHCP) to retrieve an IP Address. The Relay sends a DHCP Request to the eNB 5 through the established Default SAE Bearer which is terminated at the eNB 5. The eNB 5 may act as a DCHP Relay and forward the request to a standalone DHCP server or the eNB 5 may contain a DHCP server. The IP address allocated to the Relay is given from a pool of addresses pre-allocated to the eNB 5. For this IP address the eNB 5 acts as a router, and will relay the necessary packets from the management network of the operator to the Relay, on the assigned default SAE Bearer (running directly between the Relay and eNB 5). The DCHP Response may also include the IP address of the SON (Self-Organising Network)/O&M (Operations & Maintenance) Server to be used to retrieve the configuration

The eNB 5 may be configured to firewall the IP connection to the Relay, such that connectivity to the Relay is only possible from a Management node of the Operators network.

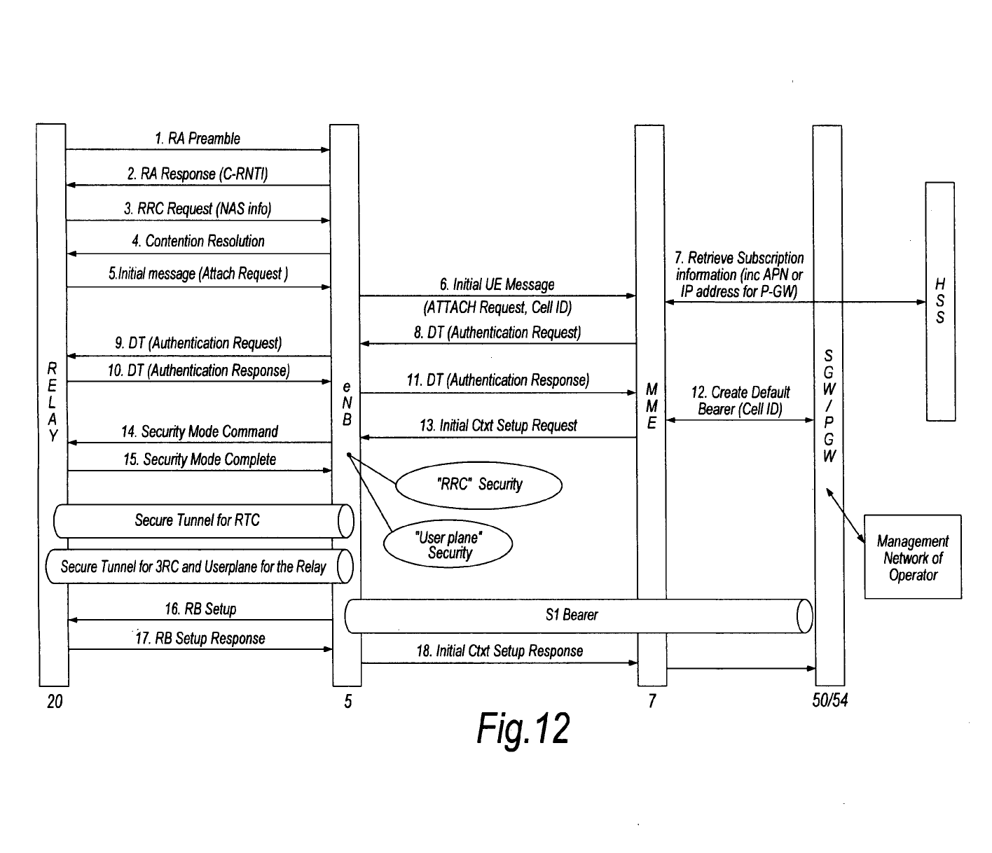

### Solution 2—IP Connectivity Required to be Provided by PDN—FIG. 12

After the UE (or relay) has performed the Initial Access procedure to its Parent Node (eNodeB 5), it sends the ATTACH message [step 5] (of the NAS Control Protocol) to the MME 7. The Relay in this case would not include an APN or any other special information. The subscription stored in the HSS 52 associated with the SIM contained in the Relay is configured with either the APN or with an IP address associated with a P-GW 50 which is connected to the Management Network of the Operator. The PDN GW 50 selected has particular properties for handling relay nodes, e.g. with optimised connection to device management server and/or the ability to use the ID of the cell the Relay is using on the eNB 5 to select the correct device management server. Interactions between the PGW 50 and network servers can occur, e.g. using RADIUS and/or Diameter protocols and the Cell ID can then be passed from the PGW 50 to the network server to permit connection to and/or selection of the correct Network Management Server.

In the Initial UE message which is carrying the Attach message the eNB 5 includes the Cell ID of the cell which the Relay is connecting through on the eNB 5, and in addition it may also include the Cell ID of the Intermediary Relays. The Cell ID information is passed to the HSS 52 when the subscription information is retrieved. The O&M server, SON server or OMA DM server can then query the HSS 52 for the Cell ID of the parent cell of the Relay to determine which configuration information to load on the Relay. Additionally a change in the Cell ID can be used to determine whether the Relay has been moved around the network.

The Relay is then allocated a Default SAE Bearer which would only have connectivity to the Management Network of the operator. The Relay can either use DHCP to request an IP address, with the DCHP Response including the IP address of the SON/O&M Server to be used to retrieve the configuration; or the Relay is allocated an IP address as part of the Attach process. The Relay is configured with the FQDN of the configuration server to be used for the device configuration—this could be an O&M server, SON server or OMA DM server.

Note: In the following discussion in this specification it is assumed that solution 1 is adopted, but this is just to avoid duplication, and the NAS procedures and Userplane connection can be seen as a separate entity as in solution 2.

### Common Aspects

Once the Authentication procedure has been completed the Relay has generated a set of keys to be used for ciphering and integrity protection of control and user plane over the radio (as with conventional LTE). The eNB 5 is provided with the security keys associated with the last Authentication procedure. The eNB 5 stores these keys and sends the Security Mode Command message to the Relay which triggers the Relay to turn on ciphering and integrity protection of the UE-eNB links. Note: The Security Mode Command and the radio bearer Setup procedures may be combined into a single procedure.

In the radio bearer Setup message sent to the Relay (Step 12 in solution 1, FIG. 11), the Relay is assigned multiple bearers for:
Transport of NAS control messages
Default SAE Bearer which is used to allow IP connections directly with the Relay.
Transport of the new 3RC protocol

The Direct Transfer (DT) messages which transport the NAS messages over the radio are passed over the radio bearer defined for the transport of NAS messages.

The new 3RC protocol is a tunnel directly between each Relay and its parent eNB and is used for signalling procedures that do not impact the intermediary Relays and is especially used to pass the UE profile including RRC cipher keys directly to the Controlling Relay (i.e. the Relay directly controlling the UE) in a secure fashion.

Note: Alternatively, the 3RC protocol could become part of the RTC protocol, with the communications between the eNB and the Controlling Relay being passed hop-by-hop.

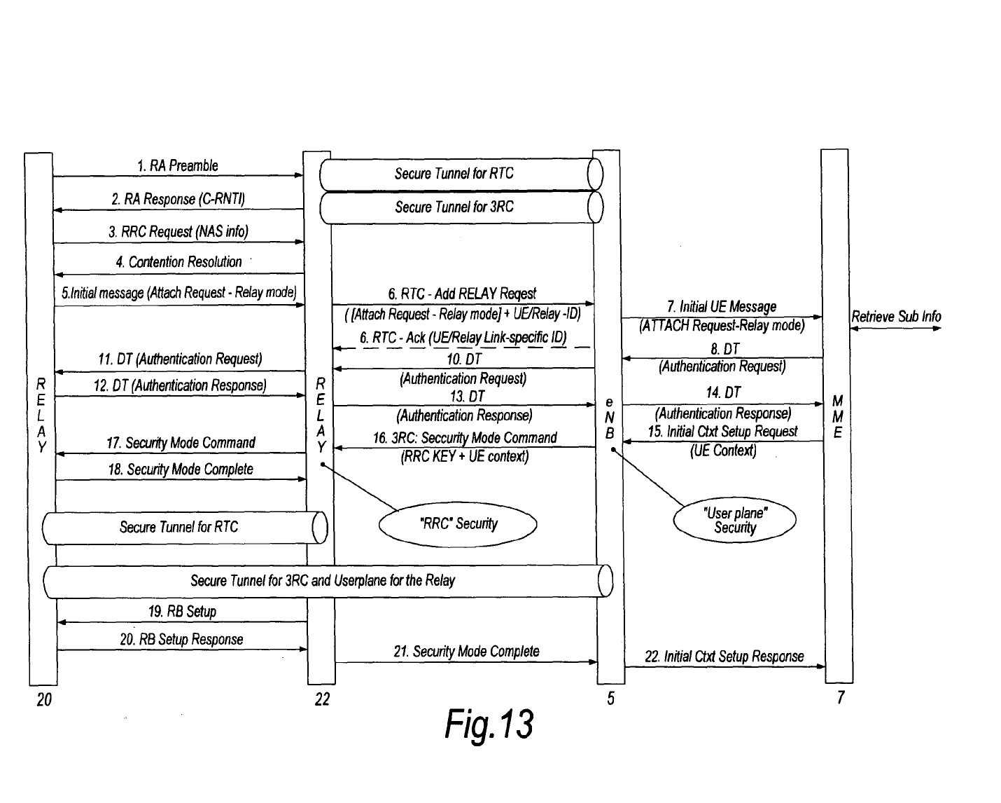

### Second-hop Relay—FIG. 13

When the next Relay is added to the system, it may need to through connect to an existing Relay to connect to the eNB 5.

When considering the multi-hop case, the reason for having a separate RTC and 3RC protocol is now explained. The RTC protocol is a method to communicate on a hop by hop basis, whereas the 3RC is used for end-to-end communication within the access network. The 3RC protocol allows the eNB 5 to communicate to the Controlling Relay 20 and pass security keys to the entity without any intermediary Relays seeing their communication.

Note: Alternatively, if the eNB-Controlling Relay security is not required, the 3RC protocol could become part of the RTC protocol, with the communications between the eNB and the Controlling Relay being passed hop-by-hop.

The Add Relay Request message (step 6) of the RTC protocol is used to create a Relay specific link between the Intermediary Relay and the eNB, and once this UE/Relay specific link has been created the DT messages of the connecting Relay can be routed to the eNB by the Intermediary Relay.

The eNB 5 uses the 3RC protocol to download the profile of a new Relay to the Intermediary/Controlling Relay. The security mode command message is passed from the eNB 5 to the Controlling Relay 20 through the 3RC protocol. This message includes the security keys to be used between the Connecting Entity (a UE or Relay) and the Controlling Relay and as they are passed through the 3RC protocol they are protected from snooping at any Intermediary Relays between the eNB and the Controlling Relay 20. At the Controlling Relay 20 the keys are removed from the message and ciphering is turned on in the uplink at the Controlling Relay 20, and the message is passed over the air to the Connecting Entity in the Downlink. If the uplink Security Mode Complete message in the uplink is correctly decoded, the Controlling Relay enables the DL ciphering/security and informs the eNB 5 through the direct 3RC tunnel.

The 3RC direct tunnel becomes more important when UEs connect to the 2-hop Relay, or when a 3rd hop Relay is connected. This security design is modular and scaleable such that it is independent of the number of hops introduced, i.e. once a Relay is designed to support child Relays, it is transparent to the Relay whether those Relays themselves have children.

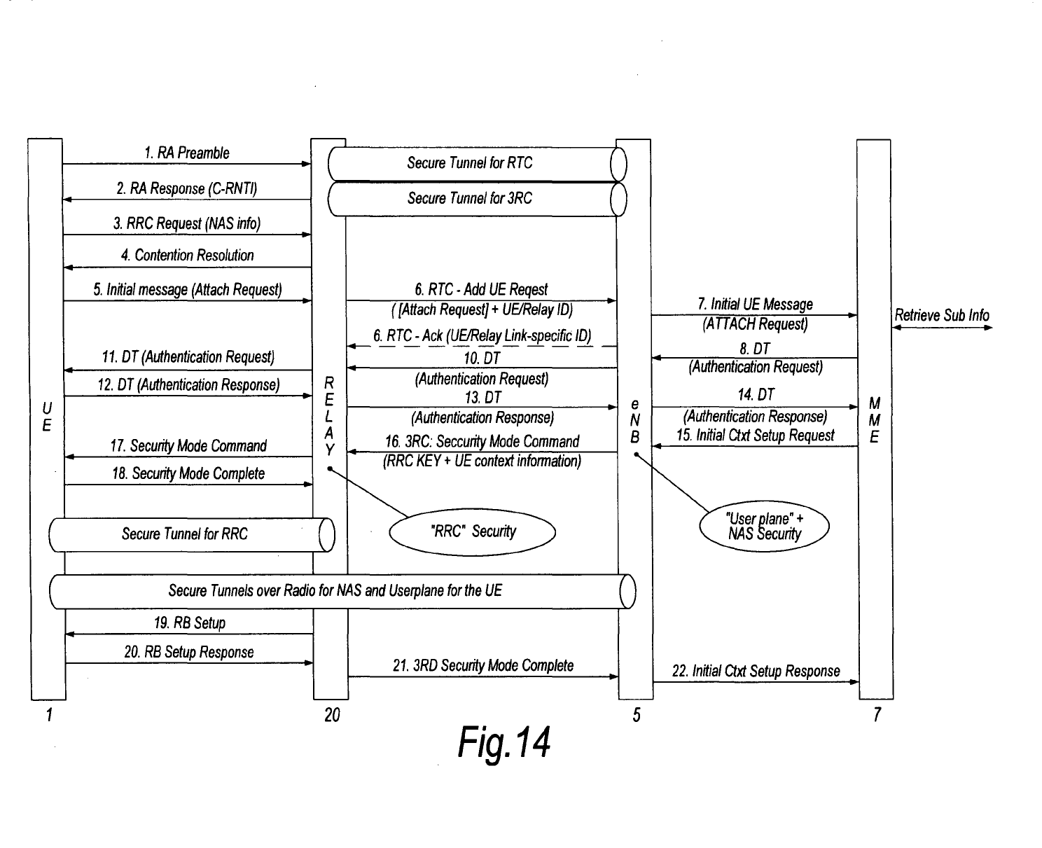

### UE Security Architecture—FIG. 14

Advantageously, according to the embodiment, the design of the UE (including the security) should not deviate from that defined for LTE Rel-8. The main difference in the embodiment is that the RRC ciphering is bridged at the Controlling Relay, between the UE specific secure tunnel and the Controlling-Relay-specific secure 3RC tunnel to the eNB 5. The UE specific messages are tagged with the UE ID when they passed through the Controlling Relay Specific secure RTC tunnel.

The Add UE Request message (Step 6) is part of the RTC protocol running between the Relay and its next hop node. This message informs the parent node that the UE 1 has connected to the Relay Cluster, and an identity for the UE 1 is negotiated between the Relay and its parent to pass messages about this UE 1, and schedule resources.

The Security Mode Command and Security Mode Complete (Steps 16 & 21) are part of the 3RC protocol, which allows the eNB 5 to directly download the UE context and RRC Keys to the Controlling Relay 20 in a secure and transparent manner independently of the number of Intermediary Relays between the eNB 5 and the Controlling Relay 20.

Note: Alternatively, the 3RC protocol could become part of the RTC protocol, with the communications between the eNB 5 and the Controlling Relay being passed hop-by-hop—however this would not provide the security to the UE Keys within the Intermediary Relay nodes.

The headings used in this description shall have no effect on the meaning to be given to any part of the description.

1. A mobile telecommunications network, comprising:
a plurality of nodes;
a network core;
a plurality of mobile telecommunications devices, that are registered with the network and communicate with the network core via the nodes; and
at least one relay provided between at least one of said nodes and at least one of said telecommunications devices to extend the radio coverage provided by the said node, wherein radio resource control signalling is securely tunnelled between the relay and the said node.

2. The network of claim 1, wherein mobility management and session management signalling is securely tunnelled between the relay and the node.

3. The network of claim 1, wherein said signalling is derived from the device.

4. The network of claim 1, wherein the radio resource control signalling is securely tunnelled between the device and the relay.

5. The network of claim 1, wherein the relay includes an attaching mechanism for attaching to the network core via the node such that the attaching procedure corresponds to that of one of said telecommunications devices.

6. The network of claim 5, wherein the node is operable to provide the telecommunications device with an IP address as part of the attach procedure via the relay.

7. The network of claim 5, wherein the network core is operable to provide the telecommunications device with an IP address as part of the attach procedure via the relay.

8. The network of claim 1, wherein the node is operable to configure the relay by said tunnelled radio resource control signalling.

9. The network of claim 1, further comprising:
one or more further relays in a communication path between the relay and the node.

10. The network of claim 9, wherein the said relay is operable to communicate directly with the device and is operable to tunnel said radio resource control signalling between the said relay and said node.

11. The network of claim 9, wherein the said relay is operable to tunnel cipher keys between the relay and said node.

12. The network of claim 9, wherein each of said one or more further relays is operable to route radio link control data packets between the node and the relay.

13. A method of operating a mobile telecommunications network including a plurality of nodes and a network core, wherein a plurality of mobile telecommunications devices are registered with the network and communicate with the network core via the nodes, wherein at least one relay is provided between at least one of said nodes and at least one of said telecommunications devices to extend the radio coverage provided by the node, the method comprising:
securely tunnelling radio resource control signalling between the relay and the node.

14. The method of claim 13, wherein mobility management and session management signalling is securely tunnelled between the relay and the node.

15. The method of claim 13, wherein said signalling is derived from the device.

16. The method of claim 13, wherein the radio resource control signalling is securely tunnelled between the said device and the relay.

17. The method of claim 13, wherein the relay includes an attaching mechanism for attaching to the network core via the said node such that the attaching procedure corresponds to that of one of said telecommunications devices.

18. The method of claim 17, wherein the node provides the telecommunications device with an IP address as part of the attach procedure via the relay.

19. The method of claim 17, wherein the network core provides the telecommunications device with an IP address as part of the attach procedure via the relay.

20. The method of claim 13, wherein the node configures the relay by said tunnelled radio resource control signalling.

21. The method of claim 13, further comprising:
providing one or more further relays in a communication path between the relay and the node.

22. The method of claim 21, wherein the relay is operable to communicate directly with the device and is operable to tunnel said radio resource control signalling between the relay and said node.

23. The method of claim 21, wherein the relay tunnels cipher keys between the relay and said node.

24. The method of claim 21, wherein each of said one or more further relays routes radio link control data packets between the node and the relay.
